(19) United States
(12) Patent Application Publication
(10) Pub. No.: US 2007/0246978 A1
(43) Pub. Date: Oct. 25, 2007

(54) Ventilative cycle saddle

(76) Inventor: Tsai-Yun Yu, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/481,897

(22) Filed: Jul. 7, 2006

(30) Foreign Application Priority Data
Apr. 24, 2006 (TW) 95114565

(51) Int. Cl. B62J 1/18

(52) U.S. Cl. 297/214

(57) ABSTRACT

A bicycle saddle has a base frame and a pad covered on the base frame. The base frame has a narrow front portion with a plurality of first lower ventholes and a wide rear portion with a plurality of second lower ventholes. The pad has a plurality of first and second upper ventholes which are arranged in such a way that each upper venthole respectively corresponds to each lower venthole to together define an air channel. Whereby ambient air can flow through the whole areas of the saddle contacting with the buttocks and inner thighs of the cyclist during cycling to provide a better ventilation effect.

### BACKGROUND OF THE INVENTION

1. Field of the Invention

The present invention generally relates to a cycle saddle, particularly to a cycle saddle with ventilation function.

2. Description of the Related Art

The typical bicycle saddle generally consists of a base, a pad, and a cover. The base acts to impart rigidity and form to the saddle, the pad provides resilient support to the cyclist, and the cover provides a soft surface and protects the pad. A disadvantage of the typical bicycle saddle is that the cyclist suffers from high heat generated at the buttocks and inner thighs of the cyclist due to repeated frictional movements at the buttocks and the inner thighs of the cyclist. The cyclist sweats and thus feels uncomfortable and sometimes has rashes.

U.S. Pat. No. 6,322,139 discloses a bicycle saddle for resolving the disadvantage of the typical bicycle saddle mentioned above. This saddle includes a recessed portion in an upper side thereof, the recessed portion including a bottom having at least one opening. A guide plate is mounted in the bicycle saddle and includes an inlet that faces a front of the bicycle saddle. The guide plate and the bottom of the recessed portion of the bicycle saddle together define a channel that communicates the inlet with the opening of the recessed portion of the bicycle saddle. A side vent is defined in each lateral side of the bicycle saddle. Thus, ambient air enters the recessed portion via the opening in the recessed portion and the side vents of the bicycle saddle during cycling to thereby provide a ventilation effect.

Such an improved saddle, as in practical use, was found that it can only partly solve the disadvantage of the typical bicycle saddle for the reason that there is no vent provided on the area of the saddle contacting with the buttocks of the cyclist during cycling. Thus, the cyclist still suffers from high heat generated at the buttocks of the cyclist.

Taiwan Utility Model Patent No. 553128 also discloses another improved saddle to resolve the disadvantage of the typical bicycle saddle mentioned above. The saddle herein still has a base, a pad and a cover. The upper surface of the base includes a plurality of recesses. Each recess has a hole provided on a side wall thereof. The pad has a plurality of openings to communicate with the holes provided on the base such that ambient air can flow through the saddle. Although such an improved saddle has better ventilation function than has the typical saddle but the rigidity of the saddle is largely decreased due to too many recesses and holes provided on the base thereof. Thus, the saddle herein can not steadily support the cyclist during cycling.

In addition, the prior art saddles have another disadvantage that for unremovedly being covered on the base, the pad can not be replaced easily by cyclist himself as wear and tear.

### SUMMARY OF THE INVENTION

Accordingly, one aspect of the present invention that is different with the prior art is that the base and the pad are specially designed in such a way that both can define together a plurality of venting channels positioned on the whole area with which that the buttocks and inner thighs of the cyclist contacts during cycling. Furthermore, the venting channels of the present invention are contemplated to have superior ventilation function and will not weaken the original intensity of the saddle.

Another aspect of the present invention is to provide a cycle saddle that the pad thereof can be easily removed from or attached to the base thereof.

Therefore, the saddle of the present invention includes a narrow front portion, a wide rear portion and a center axis along the length direction thereof. The primary members of the saddle are a base frame and a pad covered on the base frame. The base frame has a narrow front portion provided with a plurality of first lower ventholes and a wide rear portion provided with a plurality of second lower vent holes. The first and second lower ventholes are lined up in at least a row along the center axis of the saddle. The pad has also a narrow front portion provided with a plurality of first upper ventholes and a wide rear portion provided with a plurality of second upper ventholes. The upper ventholes are arranged in such a way that each upper venthole respectively corresponds to each lower venthole and together defines an air channel through the saddle, whereby ambient air can flow through the whole areas of the saddle that contact the buttocks and inner thighs of the cyclist during cycling to provide better ventilation function.

In a preferred embodiment of the present invention, the base frame of the saddle is designed to have a perimeter edge with an opening channel. The pad of the saddle has a downwardly extending lip to be embedded into the channel of the base frame via the opening thereof when the pad is covered on the base frame.

### BRIEF DESCRIPTION OF THE DRAWINGS

FIG. 1 is a perspective view of a bicycle saddle made according to the present invention;

FIG. 2 is an exploded perspective view of the bicycle saddle of FIG. 1;

FIG. 3 is a top view of a base frame of the bicycle saddle of FIG. 1;

FIG. 4 is a bottom view of a base frame of the bicycle saddle of FIG. 1;

FIG. 5 is a sectional view of the base frame taken along line 5-5 of FIG. 2;

FIG. 6 is a sectional view of the base frame taken along line 6-6 of FIG. 2;

FIG. 7 is a bottom view of a pad of the bicycle saddle of FIG. 1;

FIG. 8 is a sectional view of the pad taken along line 8-8 of FIG. 2;

FIG. 9 is a sectional view of the pad taken along line 9-9 of FIG. 2; and

FIG. 10 is a sectional view of the bicycle saddle taken along line 10-10 of FIG. 1.

### DETAILED DESCRIPTION OF THE INVENTION

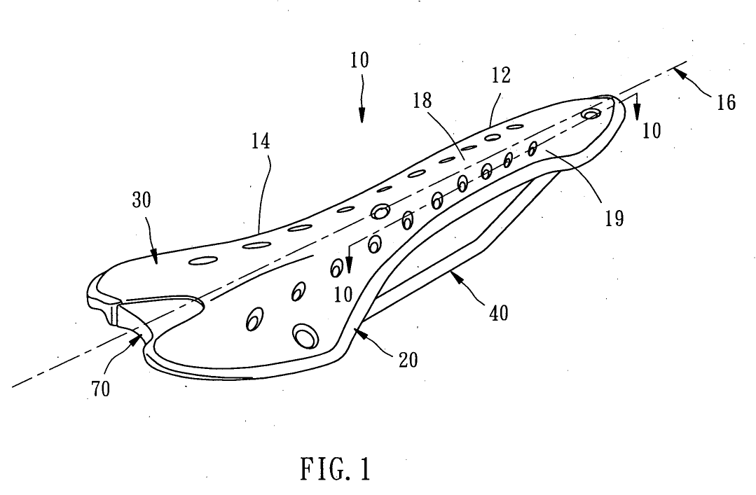

A bicycle saddle embodied according to the present invention is shown generally at 10 in FIG. 1. The bicycle saddle 10 has a narrow front portion 12 and a wide rear portion 14 extending backwardly from the front portion 12. The saddle 10 has a center axis 16 along the length direction thereof. The front portion 12 has a raised longitudinal center portion 18 along the center axis 16 with side surfaces 19 that slope downwardly from the center portion 18 to a perimeter edge of the front portion 12.

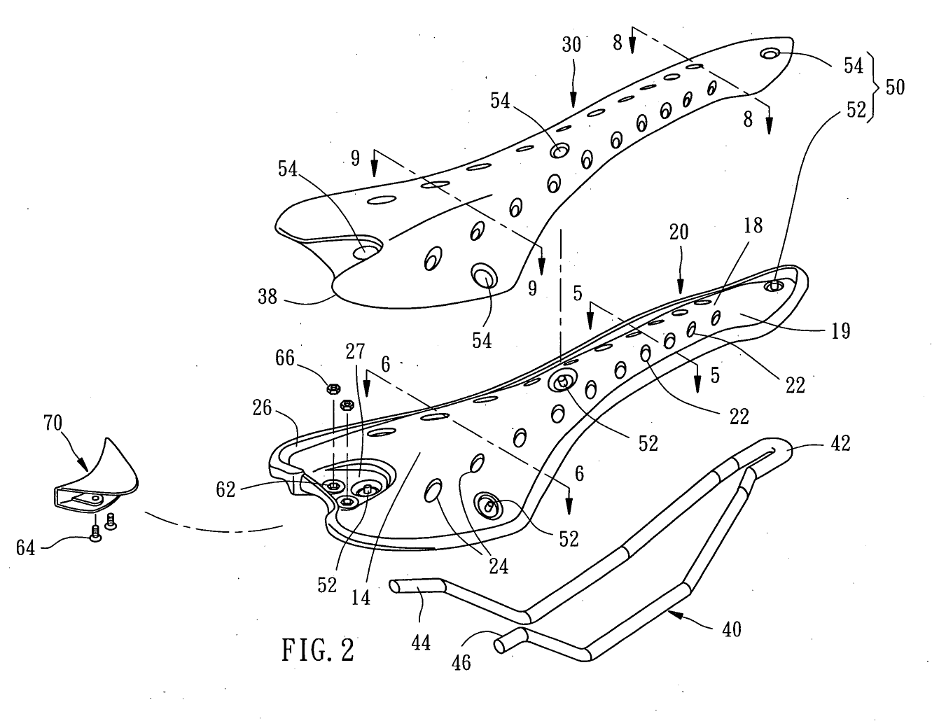

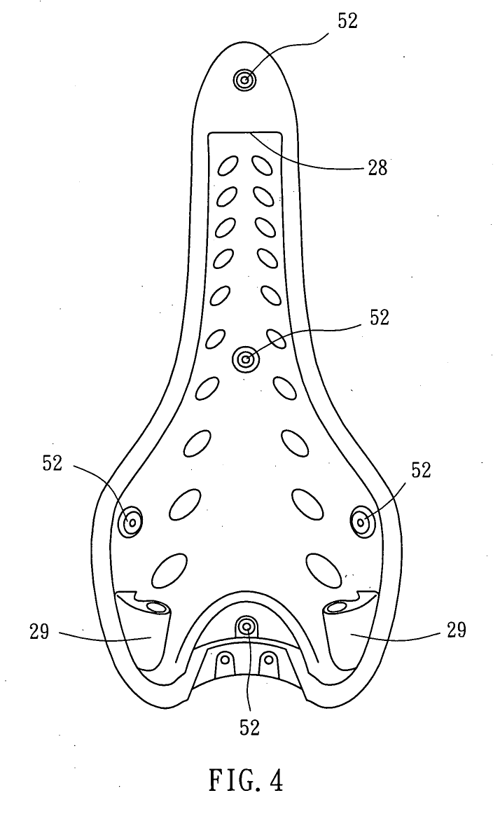

Referring to FIGS. 2-6, the bicycle saddle 10 includes a base frame 20, a pad 30 and a mounting rod 40. The base frame 20 is made of molded plastic, or any other lightweight, rigid materials, such as fiberglass or aluminum. The base frame 20 also has a front portion and a rear portion. The front portion is provided with a plurality of first lower ventholes 22 and the rear portion is provided with a plurality of second lower ventholes 24. The first and second lower ventholes 22, 24 are arranged in such a way that all of them are lined up to form a pair of mirrored rows centered by the center axis 16.

In other words, the first lower ventholes 22 are distributed in a pair of mirrored rows and each is located respectively on one of the side surfaces 19 of the saddle 10. The rear portion 14 of the saddle is divided into two contacting surfaces by the center axis 16 of the saddle 10. The second lower ventholes 24 are also distributed in a pair of mirrored rows and each is located respectively on one side of the rear portion 14 of the saddle 10.

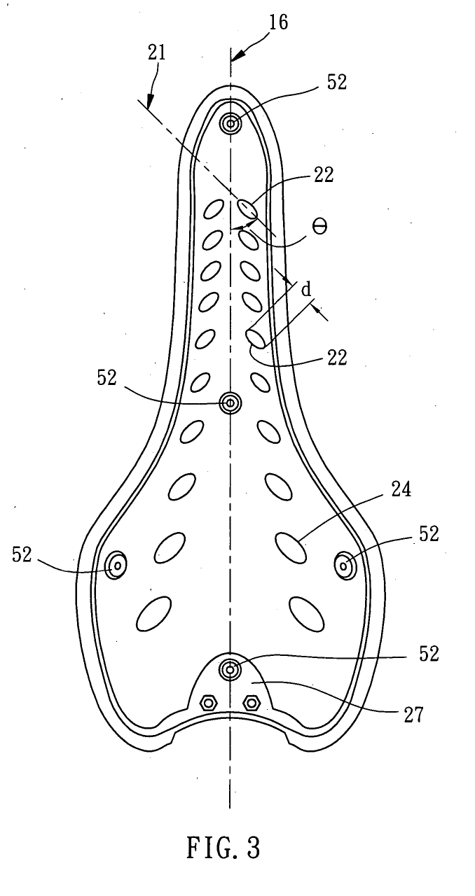

The lower venthole is designed to have a major axis 21 intersecting the center axis 16 of the saddle 10 with an included angle θ of 30 degrees, in this embodiment, it is oval-shaped, as shown in FIG. 3. In addition, the dimension of each lower venthole 22, 24 is also designed in such a way that the length of the major axis 21 is gradually increased from the front end of the saddle 10 to the rear end of the saddle 10.

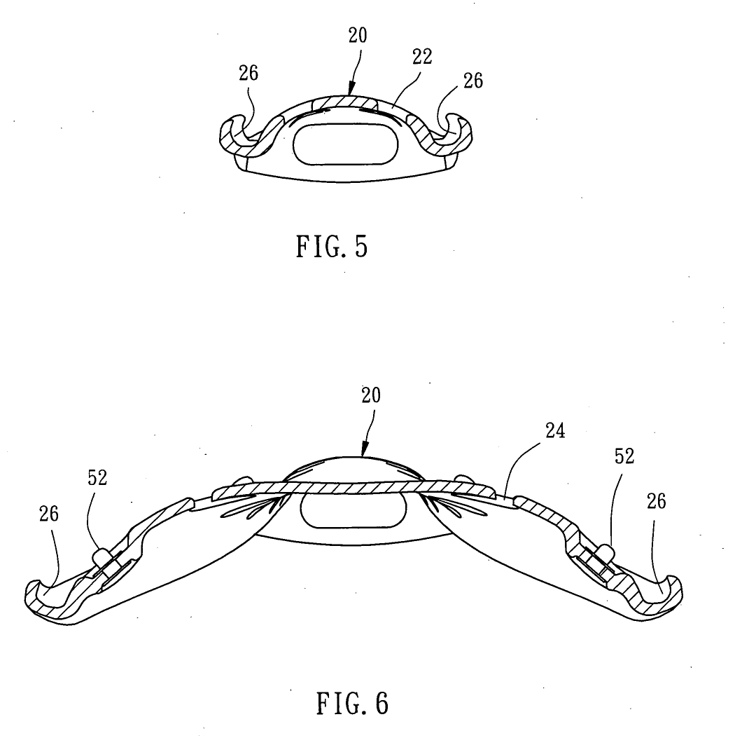

The base frame 20 further includes a perimeter edge with an opening channel 26 inclining to the inner side of the base frame 20, as shown in FIGS. 5 and 6. The upper surface of the base frame 20 has a rear end with an arrow-shaped lower recess 27. The lower surface of the base frame 20 has a front end with a receiving room 28 and a rear end with two apertures 29.

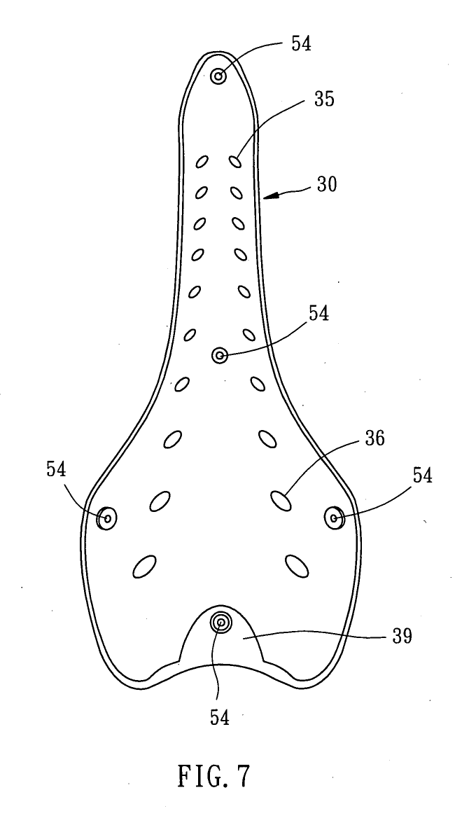

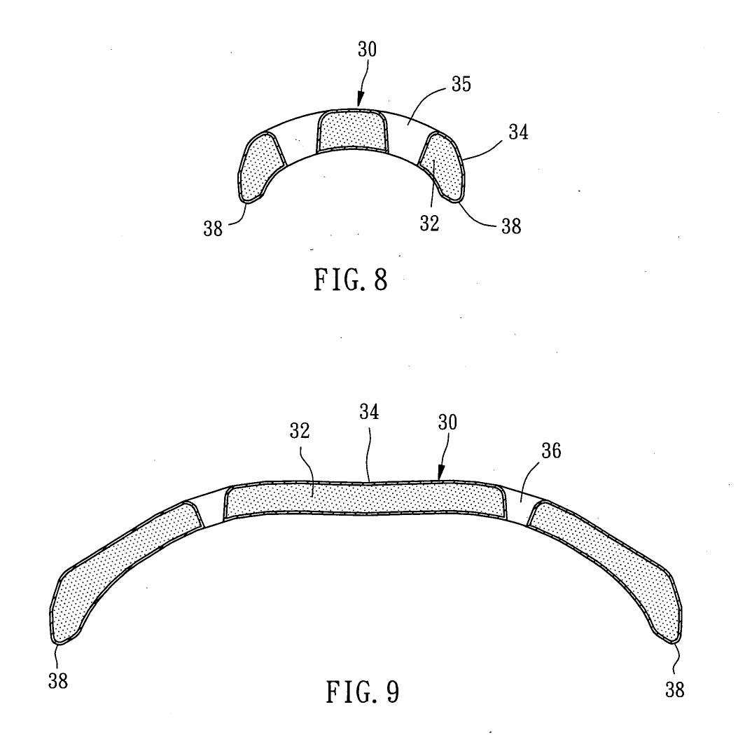

Referring now to FIGS. 7-9, the pad 30 is covered on the upper surface of the base frame 20. The pad 30 has a body 32 made of resilient materials, such as plastic foams or gel, and a protective cover 34 made of soft and thin materials, such as cloths or non-woven cloths.

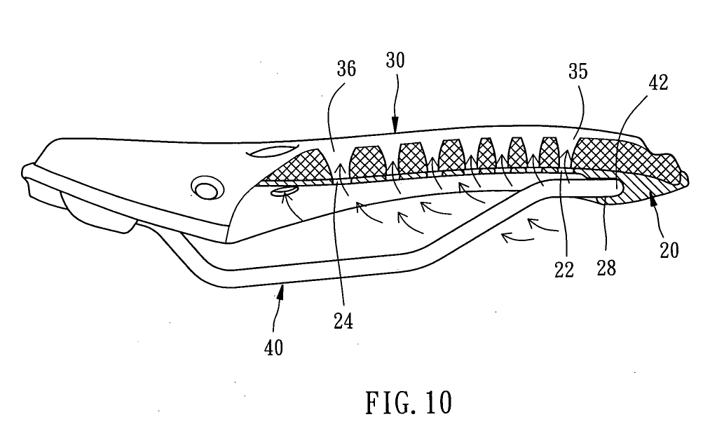

The pad 30 has a suitable thickness and a plurality of first and second upper ventholes 35, 36 arranged in such a way that each upper venthole is aligned respectively with one of lower ventholes to together define an air channel through the saddle 10, as shown in FIG. 10, whereby ambient air will flow through the saddle 10 via the air channels during cycling to provide ventilation function. Each upper venthole 35, 36 is also oval-shaped and has a major axis with a length thereof gradually increased from the front end of the saddle 10 to the rear end thereof. Moreover, the pad 30 has a downwardly extending lip 38 and an arrow-shaped upper recess 39. When the pad 30 is covered on the base frame 20, the lip 38 is embedded into the channel 26 from the opening thereof and the upper recess 39 is lodged in the lower recess 27.

The mounting rod 40 has a U-shape closed end 42 and two parallel opened end 44 46 extending from the closed end 42. In combination, the closed end 42 is received in the receiving room 28 and each opened end 44 46 is inserted respectively into each aperture 29.

For tightly attaching the pad 30 to the base frame 20, the present invention further includes a fastening means 50 located between the pad 30 and the base frame 20. In this embodiment, there are five sets of the fastening means 50 averagely distributed between the pad 30 and the base frame 20. The fastening means 50 could be a button-and-hole arrangement. In other words, The fastening means 50 has a button member 52 mounted on the upper surface of the base frame 50 and a hole member 54 mounted on the lower surface of the pad 30 corresponding to the button member 52. When the pad 30 is covered on the base frame 20, the button member 52 and the hole member 54 will be buttoned together. Further, a screw-connecting means 60 is provided between the upper and lower recess 27 39. The screw-connecting means 60 includes a threaded hole 64 provided on the lower recess 27, a bolt 64 and a nut 66. A decorating clip 70 clips the upper and lower recess 39 27 together.

As the structure mentioned above, the areas of the saddle that would contact with the buttocks and inner thighs of the cyclist during cycling have air channels defined by the upper and lower ventholes such that ambient air can flow through the air channels during cycling to provide an excellent ventilation effect, as shown in FIG. 10.

Moreover, for having slope side surfaces 19 provided with a plurality of ventholes, the saddle 10 has no obstacles to resist ambient air flowing through the specified area of the saddle with that the buttocks of the cyclist contacts during cycling. Thus, the disadvantage of the prior art can be effectively eliminated.

In addition, the pad 30 is designed to have the downwardly extending lip 38 embedded into the opening channel 26 of the base frame 20, and the pad and the base frame have five sets fastening means 50 arranged therebetween such that the saddle has the advantage that the pad thereof can be easily removed from or attached to the base frames thereof.

1. A bicycle saddle having a narrow front portion, a wide rear portion, and a center axis along the length direction thereof, said saddle comprising:
a base frame having a narrow front portion with a plurality of first lower ventholes and a wide rear portion with a plurality of second lower ventholes, said first and second lower ventholes lined up in at least a row along the center axis of said saddle;
a pad covering said base frame, said pad having a narrow front portion with a plurality of first upper ventholes and a wide rear portion with a plurality of second upper ventholes; and
said first and second upper ventholes arranged in such a way that each said upper venthole respectively corresponds to each said lower venthole to together define an air channel, whereby ambient air can flow through the whole areas of the saddle that contact the buttocks and inner thighs of the cyclist during cycling to provide a better ventilation effect
wherein said first and second lower ventholes of said base frame are arranged in such a way that all of said first and second lower ventholes are lined up to form a pair of mirrored rows centered by the center axis,
each said lower venthole has a major axis with an extending line intersecting the center axis of said saddle with an including angle being less than ninety degrees,
each said lower venthole is oval-shaped, and
the dimension of each said lower venthole is designed in such a way that the length of the major axis thereof is gradually increased from the front end of the saddle to the rear end of the saddle.

2. (canceled)

3. (canceled)

4. The bicycle saddle as claimed in claim 1, wherein said included angle is 30 degrees.

5. (canceled)

6. (canceled)

7. The bicycle saddle as claimed in claim 1 wherein said base frame has a perimeter edge with an opening channel and said pad has a downwardly extending lip embedded in said channel of said base frame.

8. The bicycle saddle as claimed in claim 1, further comprising a fastening means located between said pad and said base frame.

9. The bicycle saddle as claimed in claim 8 wherein said fastening means has a button member mounted on the upper surface of said base frame and a hole member mounted on the lower surface of said pad corresponding to said button member.

10. A bicycle saddle having a narrow front portion, a wide rear portion, and a center axis along the length direction thereof, said saddle comprising:
a base frame having a narrow front portion with a plurality of first lower ventholes and a wide rear portion with a plurality of second lower ventholes, said first and second lower ventholes lined up in at least a row along the center axis of said saddle;
a pad covered on said base frame, said pad having a narrow front portion with a plurality of first upper ventholes and a wide rear portion with a plurality of second upper ventholes;
said first and second upper ventholes arranged in such a way that each said upper venthole respectively corresponds to each said lower venthole to together define an air channel, whereby ambient air can flow through the whole areas of the saddle that contact the buttocks and inner thighs of the cyclist during cycling to provide a better ventilation effect;
said base frame having a perimeter edge with an opening channel; and
said pad has a downwardly extending lip embedded in said channel of said base frame.

11. The bicycle saddle as claimed in claim 10, further comprising a fastening means located between said pad and said base frame.

12. The bicycle saddle as claimed in claim 11, wherein said fastening means has a button member mounted on the upper surface of said base frame and a hole member mounted on the lower surface of said pad corresponding to said button member.

13. A bicycle saddle having a narrow front portion and a wide rear portion extending backwardly from said front portion and a center axis along the length direction thereof, said saddle comprising:
a base frame including a narrow front portion having a raised longitudinal center portion with side surfaces that slope downwardly from said center portion to a perimeter edge of said front portion, and a wide rear portion divided into two contacting surfaces by the center axis of said saddle;
a plurality of first lower ventholes distributed in a pair of mirrored rows and each located respectively on one of said side surfaces;
a plurality of second lower ventholes distributed in a pair of mirrored rows and each located respectively on one of the contacting surfaces of the rear portion; and
a pad shaped and configured so as to cover said base frame and, said pad having a plurality of first and second upper ventholes arranged in such a way that each said upper venthole is aligned respectively with one of said lower ventholes to together define an air channel, whereby ambient air will flow through said saddle via said air channels during cycling to provide a ventilation effect.

14. The bicycle saddle as claimed in claim 13, wherein each said lower venthole has a major axis with an extending line intersecting the center axis of said saddle with an including angle being less than ninety degrees.

15. The bicycle saddle as claimed in claim 14, wherein said included angle is 30 degrees.

16. The bicycle saddle as claimed in claim 14, wherein each said lower venthole is oval-shaped.

17. The bicycle saddle as claimed in claim 14, wherein the dimension of each said lower venthole is designed in such a way that the length of the major axis is gradually increased from the front end of the saddle to the rear end of the saddle.

18. The bicycle saddle as claimed in claim 13, wherein said base frame has a perimeter edge with an opening channel and said pad has a downwardly extending lip embedded in said channel of said base frame.

19. The bicycle saddle as claimed in claim 13, further comprising a fastening means located between said pad and said base frame.

20. The bicycle saddle as claimed in claim 19, wherein said fastening means has a button member mounted on the upper surface of said base frame and a hole member mounted on the lower surface of said pad corresponding to said button member.
